(19) United States
(12) Patent Application Publication
(10) Pub. No.: US 2019/0208911 A1
(43) Pub. Date: Jul. 11, 2019

(54) ROCKING CHAIR MASSAGER

(71) Applicant: TRUCORE DISTRIBUTORS, INC., Kings Park, NY (US)

(72) Inventors: Ming Yue Zheng, Smithtown, NY (US); Yuan Zhenbin, Guangzhou (CN)

(21) Appl. No.: 16/047,971

(22) Filed: Jul. 27, 2018

Related U.S. Application Data
(60) Provisional application No. 62/614,386, filed on Jan. 6, 2018.

(51) Int. Cl. A47C 3/029; A47C 3/025; A61H 15/00; A47C 7/14

(52) U.S. Cl. CPC A47C 3/029; A47C 3/0257; A61H 15/0078; A47C 7/144; A47C 7/38; A61H 2205/081; A61H 2205/04; A61H 2205/106; A61H 2201/0149

(57) ABSTRACT

A rocking chair massager includes a frame support including a plurality of arcuate guide rails to support a plurality of massage rollers, the frame support further including a back area coupled to the frame support, the back area including at least one padded layer disposed over the plurality of massage rollers; a headrest coupled to the frame support; a base coupled to the frame support, the base comprising a bottom surface and an arcuate top surface, the base holding at least one electric motor to power the plurality of massage rollers, the frame support coupled to the arcuate top surface via the plurality of guide rails to enable rotation of the frame support with respect to the base to provide a fully reclined position; and a pair of curved bands coupled to the bottom surface of the base support, the pair of curved bands to enable rocking.

### CROSS-REFERENCE TO RELATED APPLICATIONS

The present application is a non-provisional filing of, and claims benefit under 35 U.S.C. § 119(e) from, U.S. Provisional Patent Application Ser. No. 62/614,386, entitled “Rocking Chair Massager,” filed Jan. 6, 2018, the entirety of which is incorporated herein by reference.

### SUMMARY

A rocking chair massager, according to some embodiments includes a frame support coupled to receive a seat and a back of the rocking chair massager, the frame support including a plurality of arcuate guide rails to support a plurality of massage rollers, the frame support further including: a back area coupled to the frame support, the back area including at least one padded layer disposed over the plurality of massage rollers; a headrest coupled to the frame support; a base coupled to the frame support, the base comprising a bottom surface and an arcuate top surface, the base configured to hold at least one electric motor to power the plurality of massage rollers, the frame support coupled to the arcuate top surface via the plurality of guide rails to enable rotation of the frame support with respect to the base to enable the frame support to provide a fully reclined position of the frame support; and a pair of curved bands coupled to the bottom surface of the base support, the pair of curved bands to enable rocking back and forth by a user of the rocking chair massager.

In some embodiments, the base is connected to each band of the pair of curved bands via at least two attachment means.

In some embodiments, the headrest includes a second plurality of massage rollers.

In some embodiments, the base includes a joystick to enable a user to recline the rocking chair massager or control a massage unit powered by the at least one electric motor.

In some embodiments, the massage unit is coupled to the plurality of massage rollers and the second plurality of massage rollers, the massage unit controlled via at least the joystick, the massage modes including one or more of kneading, tapping, and Shiatsu.

In some embodiments, the position of the frame support relative to the base can be controlled by a joystick, the position including one of backward, reclining, and forward.

In some embodiments, the joystick controls a massage intensity, a hip air bag intensity, and a heat setting.

In some embodiments, the rocking chair massager includes a calf massage unit coupled to the support frame, the calf massage unit including a second massage unit for squeezing and massaging legs of a user; and a convertible foot massager accessible via pivoting the calf massage unit to expose the convertible foot massager.

In some embodiments, the pivoting the calf massage unit includes accessing the convertible foot massager by flipping the calf massage unit downward to expose the convertible foot massager.

In some embodiments, the second massage unit is coupled to the at least one electric motor.

In some embodiments, the frame support is capable of reclining a user to a full horizontal position.

In some embodiments of an apparatus disclosed herein, the support frame may be connected to each of the curved bands via a respective connection column, one end of each respective connection column connected and fixed to the support frame, and the other end passing through each curved band and connected with a respective nut; and a bottom surface of each of the one or more curved bands may be provided with a groove for accommodating the respective nut.

For some embodiments of an apparatus disclosed herein may further include: a first front pillar and a first rear pillar each connected to a bottom side of the first arc-shaped guide rail; a second front pillar and a second rear pillar each connected to a bottom side of the second arc-shaped guide rail; a first cross beam connected between a lower end of the first rear pillar and a lower end of the second rear pillar; a second cross beam connected between a lower end of the first front pillar and a lower end of the second front pillar; a first longitudinal beam connected between a first end of the first cross beam and a first end of the second cross beam; and a second longitudinal beam connected between a second end of the first cross beam and a second end of the second cross beam.

Some embodiments of an apparatus disclosed herein may further include a third cross beam connected between an upper end of the first rear pillar and an upper end of the second rear pillar.

Some embodiments of an apparatus disclosed herein may further include: a first front pillar and a first rear pillar each connected to a bottom side of the first arc-shaped guide rail; a second front pillar and a second rear pillar each connected to a bottom side of the second arc-shaped guide rail; a first cross beam connected between an upper end of the first rear pillar and an upper end of the second rear pillar; a second cross beam connected between a lower end of the first front pillar and a lower end of the second front pillar; a first longitudinal beam connected between a first end of the first cross beam and a first end of the second cross beam; and a second longitudinal beam connected between a second end of the first cross beam and a second end of the second cross beam.

Some embodiments of an apparatus disclosed herein may further include a third cross beam connected between an upper end of the first rear pillar and an upper end of the second rear pillar.

In some embodiments of an apparatus disclosed herein, a mounting plate may be connected between the first cross beam and the second cross beam.

Some embodiments of an apparatus may include: a backrest of a massage chair; a massage movement element located inside the backrest; and a covering layer arranged on the backrest to cover the massage movement element, which may include: a comfort adjustment layer; a outer layer; and a headrest connected to the outer layer.

For some embodiments of an apparatus disclosed herein, the comfort level adjustment layer may be composed of more than one layer of cotton pads.

In some embodiments of an apparatus disclosed herein, an end of at least one cotton pad may extend to form a first layer and a connecting portion.

For some embodiments of an apparatus disclosed herein, one end of the outer layer may extend to form a second connecting portion.

In some embodiments of an apparatus disclosed herein, one end of the headrest may extend to form a third connecting portion.

For some embodiments of an apparatus disclosed herein, the first connecting portion, the second connecting portion, and the third connecting portion may be attached to the back of the massage chair.

In some embodiments of an apparatus disclosed herein, the first connecting portion, the second connecting portion, and the third connecting portion may be attached to the back of the massage chair with a zipper mechanism located on a top portion of a seatback of the massage chair, and the zipper mechanism may be connected between the third connecting portion and a bead connected to the top portion of the seatback.

For some embodiments of an apparatus disclosed herein, the first connection portion and the second connection portion may be layered between the bead and the top of the seat back.

In some embodiments of an apparatus disclosed herein, lateral sides of the outer layer may be extended.

### BRIEF DESCRIPTION OF THE DRAWINGS

FIG. 1A is a schematic perspective view illustrating an example rocking chair massager support frame according to some embodiments.

FIG. 1B is a schematic perspective view illustrating an example rocking chair control compartment according to some embodiments.

FIG. 2 is a schematic perspective view illustrating an example rocking chair massager from a first perspective according to some embodiments.

FIG. 3 is a schematic perspective view illustrating an example rocking chair massager from a second perspective to some embodiments.

FIG. 4A is a schematic side view illustrating an example massage chair backrest according to some embodiments.

FIG. 4B is a schematic side view illustrating an example massage chair backrest showing an extended calf massage unit operable as a foot massager according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated in the detailed description of the drawings.

### DETAILED DESCRIPTION

### Rocking Chair Massager

Embodiments herein relate to a rocking chair massager having a chair with a fixed under the seat of the chair. A movable leg massage component is connected to the base. A guide rail is coupled to the base and the leg massage component. The base is further coupled to a moveable support frame. The moveable support frame may include front and rear track wheels. The front and rear track wheels may be installed on a guide rail and/or may be installed on the side of the backrest for other embodiments. The seatback may include separate head, back, and waist massage areas.

Some embodiments of a massage chair disclosed herein have a massage chair base capable of adjustable comfort level of the chair and providing more functions to the user. For example, a base for the massage chair includes a support frame, an arc-shaped guide rail, and an arc-shaped guide groove. Two sides of the top portion of the support frame may be connected to arc-shaped guide rails.

The arc-shaped guide rails each fit in an arc-shaped guide groove on the back of the massage chair. The arc-shaped guide grooves may extend along the arc-shaped guide rail and be attached to an inner side of the arc-shaped guide rail. The arc-shaped guides enable full extension of the massage chair as in a full reclining position.

Embodiments provide that the massage chair base is coupled to curved bands, “rockers” at the bottom of the base so that the massage chair may sway back and forth and function as a rocking chair. A user may receive a massage in the chair while rocking back and forth for better comfort. For some embodiments, the curved bands may be formed by laminating two or more layers of arc-shaped wood. In other embodiments, the curved bands include other materials, which will be appreciated by one of skill in the art.

The supporting frame, in some embodiments, may be connected to the curved bands through a connecting column. One end of the connecting column may be fixed and connected to the supporting frame. The other end may pass through the curved band and may be connected with the nut. The bottom surface of the curved bands may have a groove or recess for receiving the nut. The use of a nut for attaching the curved bands facilitate assembly and disassembly of the curved bands. The groove or recess may prevent the nut from protruding out and causing the curved foot to shake when rocked. For some embodiments, a protection plate may be located on a side of the support frame. The protection plate may protect the equipment in the base and provide a decorative function.

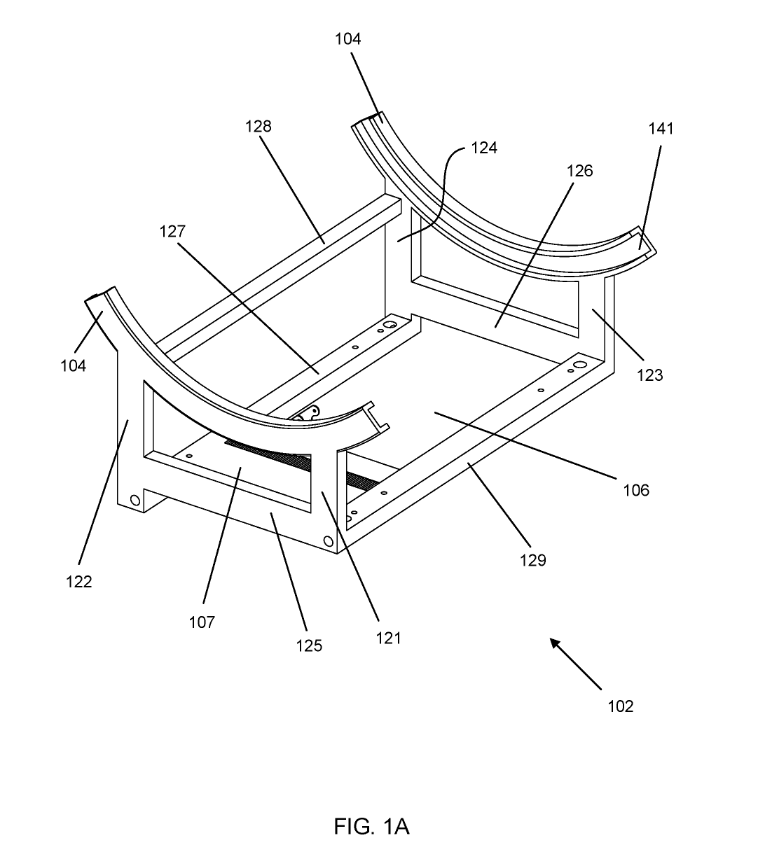

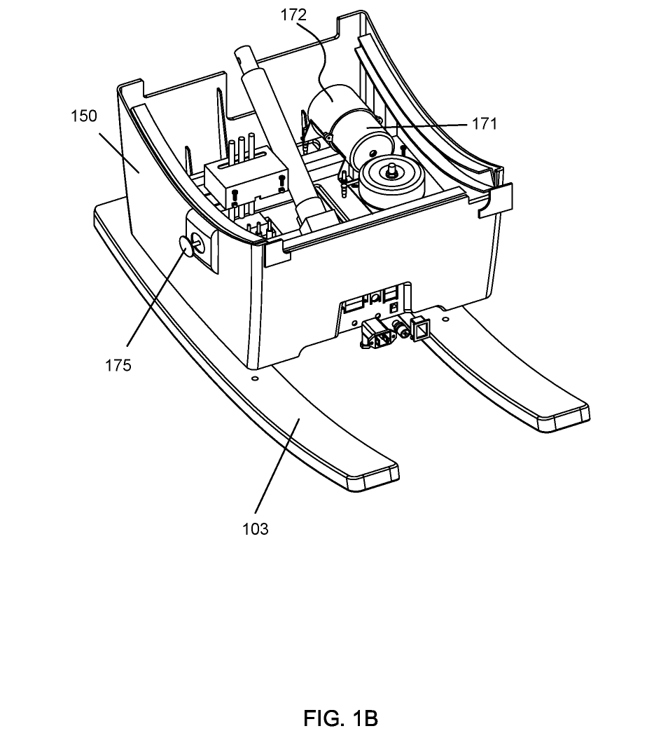

FIG. 1A is a schematic perspective view illustrating an example rocking chair support frame according to some embodiments. As shown in the embodiment of FIG. 1A, the supporting frame 102 includes a first front pillar 121, a second front pillar 123, a first rear pillar 122, and a second rear pillar 124 that are distributed in a rectangular shape. In some embodiments, a first longitudinal beam 125 may connect between the lower end of the first front pillar 121 and the lower end of the first rear pillar 122 and, and a second longitudinal beam 126 may connect between the lower end of the second front pillar 123 and the lower end of the second rear pillar 124.

A first cross beam 127 may be connected between the lower end of the first rear pillar 122 and the lower end of the second rear pillar 124. A second cross beam 128 may be connected between the upper end of the first rear pillar 122 and the upper end of the second rear pillar 124. A third cross beam 129 may be connected between the lower end of the first front pillar 121 and the lower end of the second front pillar 123.

An accommodating space 106 for mounting a device may be formed between the support frame 102, and a mounting plate 107 that may be connected between the first cross beam 127 and the third cross beam 129. With some embodiments, an air pump and other equipment may be mounted on the mounting plate 107.

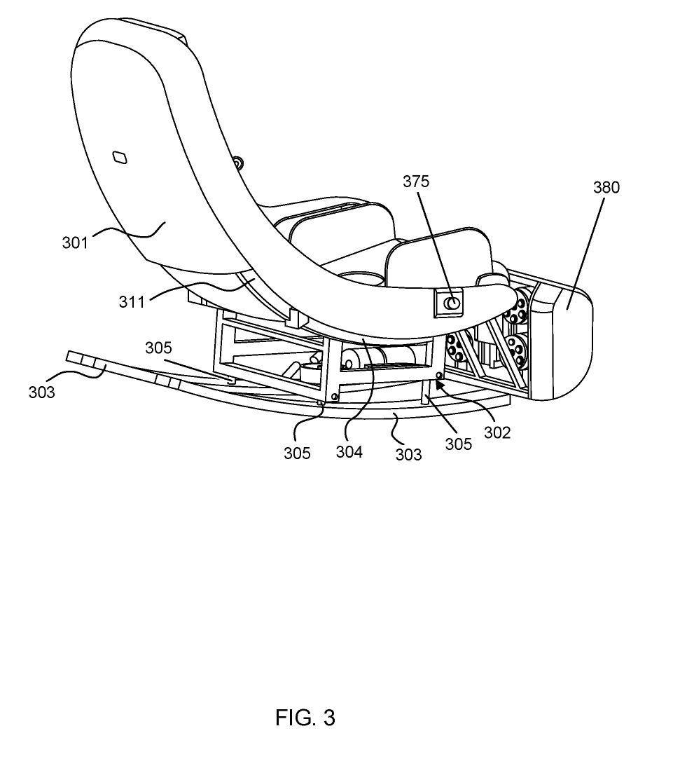

The arc-shaped guide rails 104 may be mounted on both sides of the top of the support frame 102, wherein one of the arc-shaped guide rails 104 may be attached to the upper end of the first front pillar 121 and the upper end of the first rear pillar 122. Another of the arc-shaped guide rails 104 may be attached to the upper end of the second front pillar 123 and the upper end of the second rear pillar 124. The arc-shaped guide rails 104 may be placed in an arc-shaped groove 311 of FIG. 3 located on the back of the massage chair. An arc-shaped guide groove 141 running along the arc-shaped guide rails 104 may be located on the inner side of the arc-shaped guide rails 104.

A frame may be pivotally connected to the roller through a connecting rod. The roller may be placed in the arc-shaped guide groove 141.

FIG. 1B is a schematic perspective view illustrating an example rocking chair massager control compartment according to some embodiments. As shown in FIG. 1B, an air pump housing includes a first air pump housing 171 and a second air pump housing 172. The first air pump housing 171 and the second air pump housing 72 work together to form a placement chamber. A joystick 175 may be attached to the side of the massage chair control compartment. The joystick 175 may be used by the user to control massage functions. Some embodiments have the joystick 175 mounted on the left side of the massage chair, and other embodiments have the joystick mounted on the right side of the massage chair. In some embodiments, a control compartment 150 may be attached to one or more curved bands 103, operable as “rockers”. For the example of FIG. 1B, two curved bands 103 are shown. With some embodiments, the curved bands 103 may be formed of curved wood, plastic, laminated wood or the like.

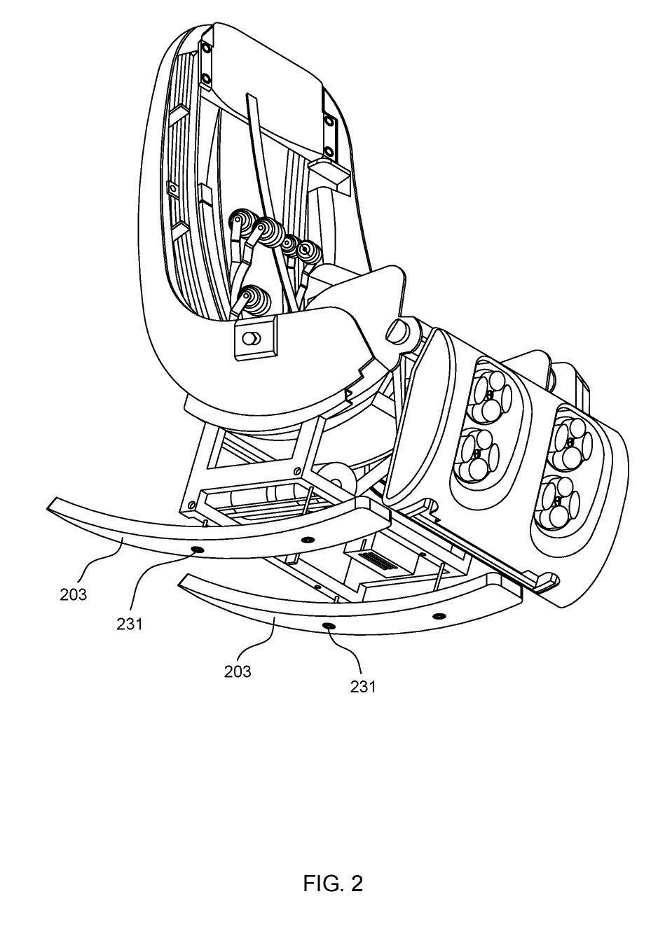

FIG. 2 is a schematic perspective view illustrating an example rocking chair massager from a first perspective according to some embodiments. As shown in FIG. 2, the bottom surface of each curved band 203 may contain a recess 231 to accommodate a nut. The recess 231 may prevent the nut from protruding out and hindering the swing of each arcuate foot 203. The curved bands 203 may be formed by pressing together two or more layers of arc-shaped wood. A compressed wood arc-shaped foot 203 may have higher strength and elasticity.

FIG. 3 is a schematic perspective view illustrating an example rocking chair massager from a second perspective to some embodiments. As shown in FIG. 3, a massage chair base may include a support frame 302, two arc-shaped guide rails 304, and two curved bands 303.

Two arc-shaped legs 303 may be arranged respectively on the two sides of the bottom of the support frame 102. Both ends of the first beam 127 and the third beam 129 shown in FIG. 1A may be connected to connecting columns 305, and the upper end of each connecting column 305 may connected to the support frame 302. Each connection may be fixed at the upper end of each connected column 305. The lower end of each connecting column 305 may pass through the arc-shaped foot 303 and be connected to the arc-shaped foot 303 with a nut. A nut may be used to facilitate assembly and disassembly with the arc-shaped foot 303.

The massage chair may drive the back 301 of the massage chair to move the massage chair back and forth along the arc-shaped guide groove. The curved bands 303 at the bottom of the base of the massage chair may rock back and forth to provide rocking of the chair. If a user uses the massage function of the massage chair, the user may be massaged in the massage chair while rocking forwards and backwards.

The joystick 375, for some embodiments, may be used to select a mode. Massage modes may include kneading, tapping, foot, calf, Shiatsu, relax, rejuvenate, soothe, and sleep. The joystick 375 also may be used to change the position of the massage chair. For some embodiments, the massage chair may be changed to be more upright (which, for example, may occur with backward movement of the joystick 375) or more reclining (which, for example, may occur with a forward movement of the joystick 375). The massage chair may be reclined to a full horizontal (or zero gravity) position in some embodiments. The joystick 375 may be used to increase or decrease massage intensity (which, for example, may occur with upward or downward movements, respectively, of the joystick 375). The joystick 375 may be used to increase or decrease hip air bag intensity. Hip air bags may compress and/or stretch a user's hips. Heated massage rollers may be used in some modes to loosen knots and tight muscles of users. Massage rollers may be used on the upper, middle, or lower body. Some embodiments use a wireless remote control in conjunction with the joystick 375 to control massage chair modes.

The massage chair may include a convertible foot massager that may be accessed by flipping and lowering a calf massage unit 380.

The relax, rejuvenate, soothe, and sleep modes are auto massage modes that may include a set of programmed massage movements. The Shiatsu mode may include heated massagers for the user's neck and back, and in some embodiments, calf and foot massage modes.

### Massage Chair Backrest

Some embodiments of a massage chair disclosed herein may include a massage chair body and a control portion. The massage chair body may include a massage chair frame, a power device, and a mechanical massage portion. The massage chair frame may include a back portion and a base portion. For the user's comfort, the angle of the backrest portion of the massage chair with respect to the ground may be adjusted. If adjusting the angle, the user may be in a sitting state, a supine (horizontal) state, or a state between the sitting and supine states.

Some embodiments of a massage chair disclosed herein provide a backrest for a massage chair that may adjust the massage output intensity to meet the needs of different people. Some embodiments of a backrest for a massage chair may include a massage core located inside the backrest, and a covering layer that covers a massage movement element.

The cover layer may include a comfort level adjustment layer, a outer layer connected to the comfort level adjustment layer, and a headrest connected to the outer layer. The comfort level adjustment layer may include more than one layer of laminated cotton pads. One end of the cotton pad may extend to form a first connecting portion, and one end of the outer layer may extend to form a second connecting portion. One end of the headrest may extend to form a third connecting portion. The first connecting portion, the second connecting portion, and the third connecting portion may be attached to the top of the seat back by an attaching device for some embodiments. The attaching device may include a zipper mechanism connected between the a bead and the third connecting portion. The bead may be attached to the top portion of the seatback. The first and second connecting portions may be located and clamped between the bead and the top portion of the seatback.

During a massage, the massage movement element may slide up and down along the guide rail set in the back of the chair. The massage ball component on the massage movement element may massage a user through swinging and tapping. With some embodiments, the output force from the massage ball component may not change.

A comfort adjustment layer between the user and the massage movement element may be used to increase or decrease the output force of the massage ball head. The size of the cotton pad may be adjusted to adjust as a result. The cotton pad(s) may be replaced or removed for cleaning. With some embodiments, each side of the outer layer may have lateral pads. Some embodiments

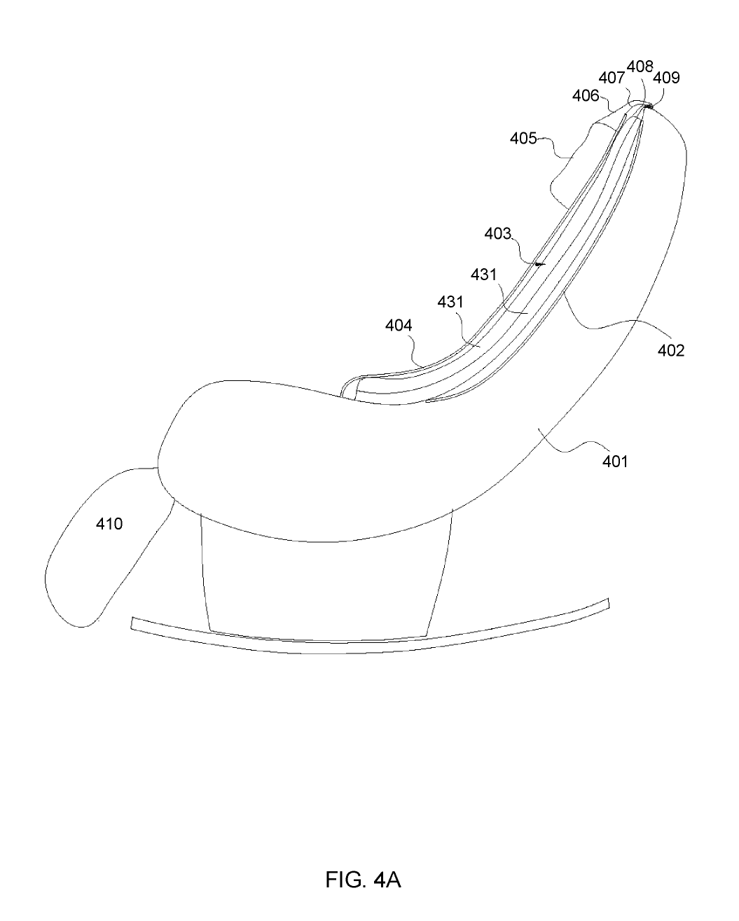

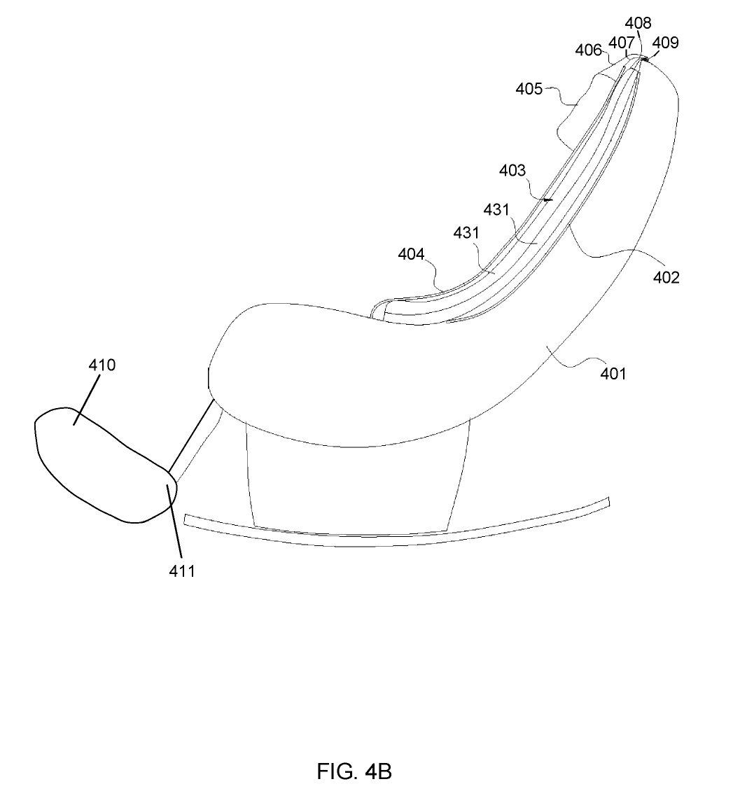

FIGS. 4A and 4B illustrate schematic side views illustrating an example massage chair backrest according to some embodiments. For some embodiments, a backrest of a massage chair may include a backrest 401, a massager body located inside the backrest 401, and a cover layer 402 located on the backrest 401 that covers the massager. The massage chair frame may include a C-shaped guide rail. The massage movement elements may move along the guide rails to massage the user's shoulder, neck, waist, and buttocks.

The massage movement may include a mounting plate and a massage assembly disposed on the mounting plate. The main component of the massage assembly is a massage ball component, which may act directly on the human body through a massage ball component to perform a massage. For some embodiments, the cover layer 402 may completely cover the massage core and the frame. The comfort layer 402 may include a comfort level adjustment layer 403 in some embodiments. The comfort level adjustment layer 403 may be composed of more than one layer of cotton pads 431, and some embodiments may have different numbers of cotton pads 431. FIG. 4 shows an example with two cotton pads 431. The comfort level adjustment layer may be provided with a outer layer 404. The outer layer 404 may have a waterproof function and be easy to clean and wash. In some embodiments, the outer layer 404 may be extended on both sides to increase the protection of both sides of the user's body. The headrest 405 may be connected to the outer layer 404.

One end of a cotton pad 431 may extend to form a first connecting portion 408. One end of the outer layer 404 may extend to form a second connecting portion 407. One end of the headrest 405 extends to form a third connecting portion 406. The two connecting portions 407 and the third connecting portion may be attached (or fixed) to the top of the seat back 401. The attaching (or fixing) device in some embodiments may include a zipper (or zipper mechanism) on the top of the seat back 401 and connected with the third connecting portion 406, and a bead 409 connected to the top of the seat back 401. The first connecting portion 408 and the second connecting portion 407 may be clamped between the bead 409 and the top of the seat back 401.

During a massage, a massage movement element may slide up and down along the guide rail provided in the seat back 401. The massage ball component on the massage movement element may massage the human body by swinging and tapping. With some embodiments, the output force from the massage ball component may be constant. A comfort level adjustment layer may lie between a user and the massage movement element. The comfort level adjustment layer, in some embodiments, may adjust the force of the massage felt by the user by increasing or decreasing the size of the cotton pad 431 to increase or decrease the strength of the massage.

Referring to FIG. 4B, in some embodiments, a calf massage element 410 can be pivoted, by flipping the calf massage element at area 411 to enable a foot massage unit to be exposed. A second massage movement element within the calf massage element can be used by the calf massage element 410 for both calf massage and/or foot massage. In some embodiments, the joystick 375 further controls massage controls for the calf massage element operable as a foot massage unit.

Some embodiments of an apparatus may include a support frame for a massage chair, wherein each of two sides of a top portion of the support frame are connected to a first and second arc-shaped guide rail, respectively; a first arc-shaped guide groove extending along the first arc-shaped guide rail and arranged on an inner side of the first arc-shaped guide rail; a second arc-shaped guide groove extending along the second arc-shaped guide rail and arranged on an inner side of the second arc-shaped guide rail; and a receiving space formed by the support frame.

For some embodiments of an apparatus disclosed herein, the arc-shaped guide rails may mate with arc-shaped grooves with an entry point on a back of the massage chair.

In some embodiments of an apparatus disclosed herein, the support frame may be connected to each of the one or more arc-shaped feet via a respective connection column, one end of each respective connection column is connected and fixed to the support frame, and the other end passes through the arc-shaped foot and is connected with a respective nut; and a bottom surface of each of the one or more arc-shaped feet may be provided with a groove for accommodating the respective nut.

For some embodiments of an apparatus disclosed herein may further include: a first front pillar and a first rear pillar each connected to a bottom side of the first arc-shaped guide rail; a second front pillar and a second rear pillar each connected to a bottom side of the second arc-shaped guide rail; a first cross beam connected between a lower end of the first rear pillar and a lower end of the second rear pillar; a second cross beam connected between a lower end of the first front pillar and a lower end of the second front pillar; a first longitudinal beam connected between a first end of the first cross beam and a first end of the second cross beam; and a second longitudinal beam connected between a second end of the first cross beam and a second end of the second cross beam.

Some embodiments of an apparatus disclosed herein may further include a third cross beam connected between an upper end of the first rear pillar and an upper end of the second rear pillar.

For some embodiments of an apparatus disclosed herein, a side of the support frame may be connected to a protection plate.

Some embodiments of an apparatus disclosed herein may further include: a first front pillar and a first rear pillar each connected to a bottom side of the first arc-shaped guide rail; a second front pillar and a second rear pillar each connected to a bottom side of the second arc-shaped guide rail; a first cross beam connected between an upper end of the first rear pillar and an upper end of the second rear pillar; a second cross beam connected between a lower end of the first front pillar and a lower end of the second front pillar; a first longitudinal beam connected between a first end of the first cross beam and a first end of the second cross beam; and a second longitudinal beam connected between a second end of the first cross beam and a second end of the second cross beam.

Some embodiments of an apparatus disclosed herein may further include a third cross beam connected between an upper end of the first rear pillar and an upper end of the second rear pillar.

In some embodiments of an apparatus disclosed herein, a mounting plate may be connected between the first cross beam and the second cross beam.

Some embodiments of an apparatus may include: a backrest of a massage chair; a massage movement element located inside the backrest; and a covering layer arranged on the backrest to cover the massage movement element, which may include: a comfort adjustment layer; a outer layer; and a headrest connected to the outer layer.

For some embodiments of an apparatus disclosed herein, one end of the outer layer may extend to form a second connecting portion.

In some embodiments of an apparatus disclosed herein, one end of the headrest may extend to form a third connecting portion.

For some embodiments of an apparatus disclosed herein, the first connecting portion, the second connecting portion, and the third connecting portion may be attached to the back of the massage chair.

In some embodiments of an apparatus disclosed herein, the first connecting portion, the second connecting portion, and the third connecting portion may be attached to the back of the massage chair with a zipper mechanism located on a top portion of a seatback of the massage chair, and the zipper mechanism may be connected between the third connecting portion and a bead connected to the top portion of the seatback.

For some embodiments of an apparatus disclosed herein, the first connection portion and the second connection portion may be layered between the bead and the top of the seat back.

In some embodiments of an apparatus disclosed herein, lateral sides of the outer layer may be extended.

What is claimed:

1. A rocking chair massager comprising:
a frame support coupled to receive a seat and a back of the rocking chair massager, the frame support including a plurality of arcuate guide rails to support a plurality of massage rollers, the frame support further including:
a back area coupled to the frame support, the back area including at least one padded layer disposed over the plurality of massage rollers;
a headrest coupled to the frame support;
a base coupled to the frame support, the base comprising a bottom surface and an arcuate top surface, the base configured to hold at least one electric motor to power the plurality of massage rollers, the frame support coupled to the arcuate top surface via the plurality of guide rails to enable rotation of the frame support with respect to the base to enable the frame support to provide a fully reclined position of the frame support; and
a pair of curved bands coupled to the bottom surface of the base support, the pair of curved bands to enable rocking back and forth by a user of the rocking chair massager.

2. The rocking chair massager of claim 1,
wherein the base is connected to each band of the pair of curved bands via at least two attachment means.

3. The rocking chair massager of claim 1, wherein the headrest includes a second plurality of massage rollers.

4. The rocking chair massager of claim 1 wherein the base includes a joystick to enable a user to recline the rocking chair massager or control a massage unit powered by the at least one electric motor.

5. The rocking chair massager of claim 4 wherein the massage unit is coupled to the plurality of massage rollers and the second plurality of massage rollers, the massage unit controlled via at least the joystick, the massage modes including one or more of kneading, tapping, and Shiatsu.

6. The rocking chair massager of claim 1 wherein the position of the frame support relative to the base can be controlled by a joystick, the position including one of backward, reclining, and forward.

7. The rocking chair massager of claim 5 wherein the joystick controls a massage intensity, a hip air bag intensity, and a heat setting.

8. The rocking chair massager of claim 1 further comprising:
a calf massage unit coupled to the support frame, the calf massage unit including a second massage unit for squeezing and massaging legs of a user; and
convertible foot massager accessible via pivoting the calf massage unit to expose the convertible foot massager.

9. The rocking chair massager of claim 8 wherein the pivoting the calf massage unit includes accessing the convertible foot massager by flipping the calf massage unit downward to expose the convertible foot massager.

10. The rocking chair massager of claim 8 wherein the second massage unit is coupled to the at least one electric motor.

11. The rocking chair massager of claim 1 wherein apparatus of claim 12, wherein the frame support is capable of reclining a user to a full horizontal position.
